(19) United States
(12) Patent Application Publication
(10) Pub. No.: US 2018/0053138 A1
(43) Pub. Date: Feb. 22, 2018

(54) SYSTEM AND METHOD FOR SECURELY TRANSPORTING CARGO

(71) Applicant: Certainty Logistics LLC, Mobile, AL (US)

(72) Inventor: Max Rodgers Nelson, JR., Mobile, AL (US)

(73) Assignee: Certainty Logistics LLC, Mobile, AL (US)

(21) Appl. No.: 15/242,550

(22) Filed: Aug. 21, 2016

(51) Int. Cl. G06Q 10/08; G06K 17/00; G06K 7/10; G06K 7/14

(52) U.S. Cl. CPC G06Q 10/083; G06K 17/0022; G06K 7/1413; G06K 7/10366; G06Q 10/087

(57) ABSTRACT

A system and method for managing the delivery of bulk materials is disclosed. The system may provide for tracking deliveries through a number of parties involved in the process, and ultimately opening a delivery valve at the unload site when the delivery arrives. The system may include web and phone versions allowing a user to scan identification codes associated with specific origin vessels, delivery vessels, and transport containers, and store information relating to those identification codes as a single load or delivery.

### FIELD OF THE INVENTION

A preferred implementation of a version of the invention refers to a system and method for managing loading, shipping, delivering, tracking, and offloading. A preferred embodiment of the system and method is directed to controlling the delivery and offloading of bulk materials.

### BACKGROUND

Currently the delivery process that involves delivery of bulk materials is a very detailed process that requires several checks of tanker tags, Bills of Lading, Carrier paperwork and delivery tank placarding. Personnel are required to determine which of one of many possible tanks should receive an incoming delivery load. This is a labor intensive job requiring many manual inputs. In some cases, specific information regarding the specifics of a tank may not be known. As such, whether to load and offload a particular material into or out of an unknown tank is a subject decision.

In some places, administrative controls have been implemented to help aid in the process. However, there are limited engineering controls that maintain the chain of custody through the supplier, transporter and end user. Current procedures use paperwork inspection and manual locking valves on the unload site. However, the current method does not account for errors in paperwork, accidental receipt of incorrect paperwork, or other errors.

Accordingly, there is a need for a system and method allowing for scanning to take place at the point of employee interface eliminating the potential for errors created by utilizing a paper and manual carrier system. Additionally, there is a need for a system and method capable of verifying a proper chain of custody exists between a specific origin vessel, specific transport container, and specific delivery vessel. There is also a need in the art for a system and method which automatically opens a valve on a delivery vessel fill line if a proper chain of custody exists. There is also a need in the art for a system and method which automatically triggers an alarm if a proper chain of custody does not exist.

### SUMMARY

In accordance with one aspect of the principles of the invention, a system and method for managing the delivery of bulk materials are provided. In one embodiment, the system provides for tracking deliveries through at least three parties involved in the process, and ultimately opening a delivery valve at the unload site when the delivery arrives.

In another embodiment, the system and method consists of a web and mobile phone versions. In some embodiments, the system may be implemented on a mobile phone application. Generally, a load relating to a specific delivery of goods is created in the database with a tank origin number, location, chemical name, hazard category and other pertinent information identified in the load. The custody is then transferred to a transport company for delivery. A user may scan a barcode that is connected to the transport container and this information will be added to the load. The user then accesses the system and selects the destination based on potential options that contain the same goods as the load tank. The transport company may then depart for delivery.

Upon arriving at an offload facility, a similar tank identification code is scanned to initiate the load validation process. The user may then scan one of the identification codes that were connected to the transport container at the load site. The system then confirms the chain of custody ensuring that the good from the origin vessel, to the transport container to the ultimate delivery vessel all match. Upon receipt of confirmation from the database, the system may send an open command to an appropriate unload valve, or other remote controlled locking devices, located on the delivery vessel's tank fill line. If the chain of custody check does not indicate that the goods match, then the system sends a signal to a visual or an audible alarm located on the hardware or valve. Alarm messaging may also be displayed on the user's smartphone indicating the incorrect tank has been scanned.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### DESCRIPTION OF THE DRAWINGS

These and other features, aspects, and advantages of the present invention will become better understood with regard to the following description, appended claims, and accompanying drawings where:

FIG. 1 is a diagram of an example environment in which techniques described herein may be implemented;

FIG. 2 is an exemplary diagram of a client of FIG. 1 according to an implementation consistent with the principles of the invention;

FIG. 3 is a diagram of an example of a computing device and a mobile computing device;

FIG. 4 is a diagram illustrating an example system configuration according to an implementation consistent with the principles of the invention;

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

Systems and methods consistent with the principles of the invention may provide solutions for managing loading, shipping, and delivery of bulk goods. For example, the systems and methods may permit users to load, ship, deliver, and track hazardous chemicals.

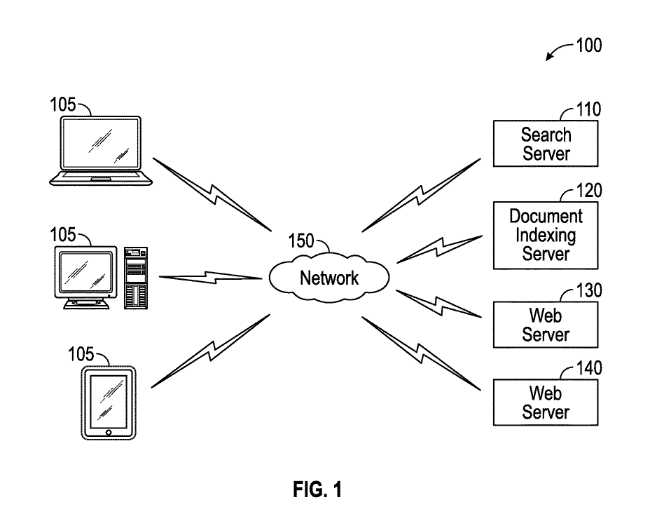

FIG. 1 is a diagram of an example environment 100 in which techniques described herein may be implemented. Environment 100 may include multiple clients 105 connected to one or more servers 110-140 via a network 150. In some implementations, and as illustrated, server 110 may be a search server, that may implement a search engine; and server 120 may be a document indexing server, e.g, a web crawler; and servers 130 and 140 may be general web servers, such as servers that provide content to clients 105. Clients 105 and servers 110-140 may be connected to network 150 via wired, wireless, or a combination of wired and wireless connections.

Three clients 105 and four servers 110-140 are illustrated as connected to network 150 for simplicity. In practice, there may be additional or fewer clients and servers. Also, in some instances, a client may perform the functions of a server and a server may perform the functions of a client.

Clients 105 may include devices of users that access servers 110-140. A client 105 may include, for instance, a personal computer, a wireless telephone, a personal digital assistant (PDA), a laptop, a smart phone, a tablet computer, or another type of computation or communication device. Servers 110-140 may include devices that access, fetch, aggregate, process, search, provide, and/or maintain documents. Although shown as single components 110, 120, 130, and 140 in FIG. 1, each server 110-140 may, in some implementations, be implemented as multiple computing devices, which potentially may be geographically distributed.

Search server 110 may include one or more computing devices designed to implement a search engine, such as a documents/records search engine, general webpage search engine, etc. Search server 110 may, for example, include one or more web servers to receive search queries and/or inputs from clients 105, search one or more databases in response to the search queries and/or inputs, and provide documents or information, relevant to the search queries and/or inputs, to clients 105. In some implementations, search server 110 may include a web search server that may provide webpages to clients 105, where a provided webpage may include a reference to a web server, such as one of web servers 130 or 140, at which the desired information and/or links is located. The references, to the web server at which the desired information is located, may be included in a frame and/or text box, or as a link to the desired information/document.

Document indexing server 120 may include one or more computing devices designed to index documents available through network 150. Document indexing server 120 may access other servers, such as web servers that host content, to index the content. In some implementations, document indexing server 120 may index documents/records stored by other servers, such as web servers 130 and 140 and, connected to network 150. Document indexing server 120 may, for example, store and index content, information, and documents relating to bulk good loading shipping, tracking, and offloading.

Web servers 130 and 140 may each include web servers that provide webpages to clients. The webpages may be, for example, HTML-based webpages. A web server 130/140 may host one or more websites. A website, as the term is used herein, may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

While servers 110-140 are shown as separate entities, it may be possible for one or more servers 110-140 to perform one or more of the functions of another one or more of servers 110-140. For example, it may be possible that two or more of servers 110-140 are implemented as a single server. It may also be possible for one of servers 110-140 to be implemented as multiple, possibly distributed, computing devices.

Network 150 may include one or more networks of any kind, including, but not limited to, a local area network (LAN), a wide area network (WAN), a telephone network, such as the Public Switched Telephone Network (PSTN), an intranet, the Internet, a memory device, another type of network, or a combination of networks.

Although FIG. 1 shows example components of environment 100, in other implementations, environment 100 may contain fewer components, different components, differently arranged components, and/or additional components than those depicted in FIG. 1. Alternatively, or additionally, one or more components of environment 100 may perform one or more other tasks described as being performed by one or more other components of environment 200.

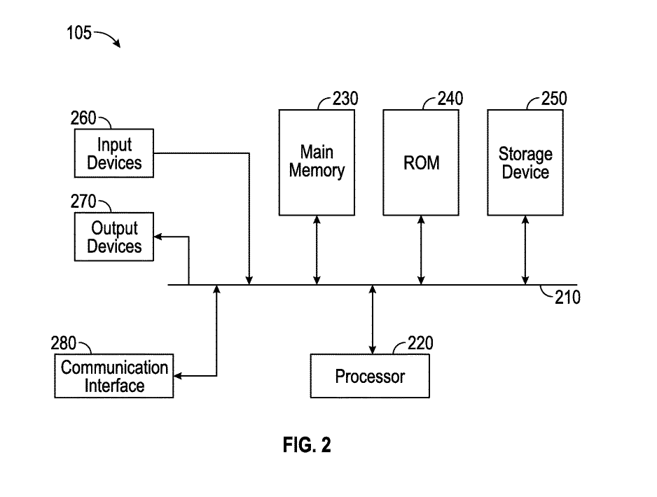

FIG. 2 is an exemplary diagram of a user/client 105 or server entity (hereinafter called “client/server entity”), which may correspond to one or more of the clients and servers, according to an implementation consistent with the principles of the invention. The client/server entity 105 may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of the client/server entity 105.

Processor 220 may include any type of conventional processor or microprocessor that interprets and executes instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device(s) 260 may include one or more conventional mechanisms that permit an operator to input information to the client/server entity 105, such as a scanner, phone, camera, scanning device, keyboard, a mouse, a pen, voice recognition and/or biometric mechanisms, etc. Output device(s) 270 may include one or more conventional mechanisms that output information to the operator, including a display, a printer, a speaker, an alarm, a valve, an actuator, etc. Communication interface 280 may include any transceiver-like mechanism that enables the client/server entity 105 to communicate with other devices 105 and/or systems. For example, communication interface 280 may include mechanisms for communicating with another device 105 or system via a network, such as network 150.

As will be described in detail below, the client/server entity 105, consistent with the principles of the invention, performs certain search, recording, and tracking operations. The client/server entity 105 may perform these operations in response to processor 220 executing software instructions contained in a computer-readable medium, such as memory 230. A computer-readable medium may be defined as one or more physical or logical memory devices and/or carrier waves.

The software instructions may be read into memory 230 from another computer-readable medium, such as data storage device 250, or from another device via communication interface 280. The software instructions contained in memory 230 causes processor 220 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

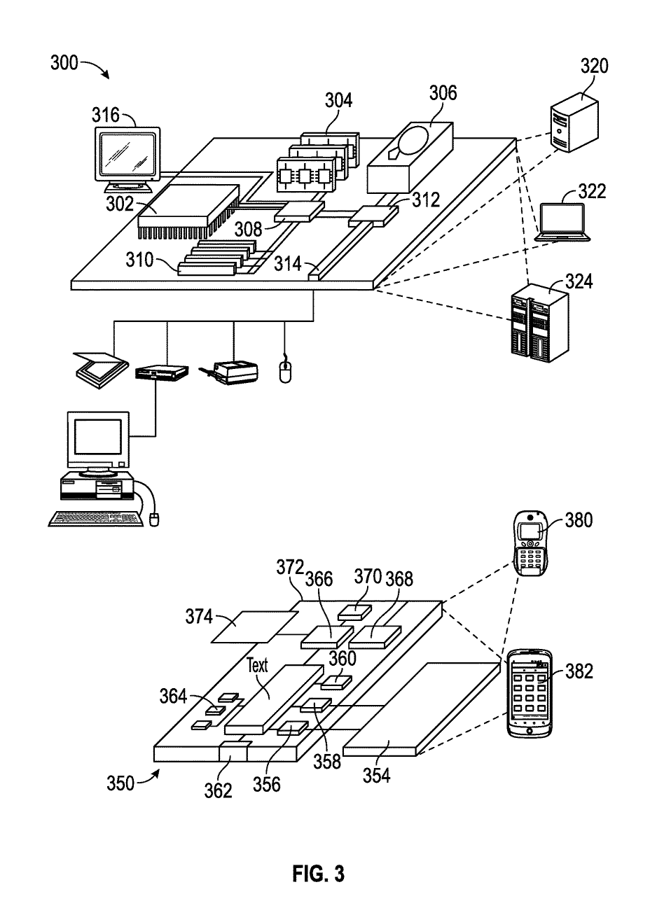

FIG. 3 is a diagram of an example of a computing device 300 and a mobile computing device 350, which may be used with the techniques described here. Computing device 300 or mobile computing device 350 may correspond to, for example, a client 205 and or a server 210-240. Computing device 300 is intended to represent various forms of digital computers, such as laptops, desktops, workstations, personal digital assistants, servers, mainframes, and other appropriate computers. Mobile computing device 350 is intended to represent various forms of mobile devices, such as scanners, scanning devices, personal digital assistants, cellular telephones, smart phones, tablet computers, and other similar computing devices. The components show in FIG. 3, their connections and relationships, and their functions, are meant to be examples only, and are not meant to limit implementations described herein.

Computing device 300 may include a processor 302, a memory 304, a storage device 306, a high-speed interface 308 connecting to a memory 304 and high-speed expansion ports 310, and a low-speed interface 312 connecting to a low-speed expansion port 314 and a storage device 306. Each of components 302, 304, 306, 308, 310, 312, and 314 are interconnected using various buses, and may be mounted on a common motherboard or in other manners as appropriate. Processor 302 can process instructions for execution within computing device 300, including instructions stored in memory 304 or on storage device 306 to display graphical information for a graphical user interface (GUI) on an external input/output device, such as display 316 coupled to high-speed interface 308. In other implementations, multiple processors and/or multiple buses may be used, as appropriate, along with multiple memories and types of memory. Also, multiple computing devices 300 may be connected, with each device providing portions of the necessary operations, as a server bank, a group of blade servers, or a multi-processor system, etc.

Memory 304 stores information within computing device 300. In some implementations, memory 304 includes a volatile memory unit or units. In another implementation, memory 304 may include a non-volatile memory unit or units. Memory 304 may also be another form of computer-readable medium, such as a magnetic or optical disk. A computer-readable medium may refer to a non-transitory memory device. A memory device may refer to storage space within a single storage device or spread across multiple storage devices.

Storage device 306 is capable of providing mass storage for computing device 300. In some implementations, storage device 306 may be or contain a computer-readable medium, such as a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 304, storage device 306, or a memory on processor 302.

High-speed interface 308 manages bandwidth-intensive operations for computing device 300, while low-speed interface 312 manages lower bandwidth-intensive operations. Such allocation of functions is an example only. In some implementations, high-speed interface 308 is coupled to memory 304, display 316, such as through a graphics processor or accelerator, and to high-speed expansion ports 310, which may accept various expansion cards. In this implementation, low-speed interface 312 may be coupled to storage device 306 and low-speed expansion port 314. Low-speed expansion port 314, which may include various communication ports, such as USB, Bluetooth, Ethernet, wireless Ethernet, etc., may be coupled to one or more input/output devices, such as a keyboard, a pointing device, a scanner, or a networking device such as switch or router, e.g., through a network adapter.

Computing device 300 may be implemented in a number of different forms, as shown in the figures. For example, computing device 300 may be implemented as a standard server 320, or in a group of such servers. Computing device 300 may also be implemented as part of a rack server system 324. In addition, computing device 300 may be implemented in a personal computer, such as a laptop computer 322. Alternatively, components from computing device 300 may be combined with other components in a mobile device, such as mobile computing device 350. Each of such devices may contain one or more computing devices 300, 350, and an entire system may be made up of multiple computing devices 300, 350 communicating with each other.

Mobile computing device 350 may include a processor 352, a memory 364, an input/output (“I/O”) device, such as a display 354, a communication interface 366, and a transceiver 368, among other components. Mobile computing device 350 may also be provided with a storage device, such as a micro-drive or other device, to provide additional storage. Each of the components 352, 364, 354, 366, and 368 are interconnected using various buses, and several of the components may be mounted on a common motherboard or in other manners as appropriate.

Processor 352 can execute instructions within mobile computing device 350, including instructions stored in memory 364. Processor 352 may be implemented as a chipset of chips that include separate and multiple analog and digital processors. Processor 352 may provide, for example, for coordination of the other components of mobile computing device 350, such as control of user interfaces, applications run by mobile computing device 350, and wireless communication by mobile computing device 350.

Processor 352 may communicate with a user through control interface 358 and display interface 356 coupled to a display 354. Display 354 may be, for example, a TFT LCD (Thin-Film-Transistor Liquid Crystal Display) or an OLED (Organic Light Emitting Diode) display or other appropriate display technology. Display interface 356 may include appropriate circuitry for driving display 354 to present graphical and other information to a user. Control interface 358 may receive commands from a user and convert the commands for submission to processor 352. In addition, an external interface 362 may be provided in communication with processor 352, so as to enable near area communication of mobile computing device 350 with other devices. External interface 362 may provide, for example, for wired communications in some implementations, or for wireless communication in other implementations, and multiple interfaces may also be used.

Memory 364 stores information within mobile computing device 350. Memory 364 can be implemented as one or more of a computer-readable medium or media, a volatile memory unit or units, or a non-volatile memory unit or units. Expansion memory 374 may also be provided and connected to mobile computing device 350 through expansion interface 372, which may include, for example, a SIMM (Single In Line Memory Module) card interface. Such expansion memory 374 may provide extra storage space for device 350, or may also store applications or other information for mobile computing device 350. Specifically, expansion memory 374 may include instructions to carry out or supplement the processes described herein, and may include secure information also. Thus, for example, expansion memory 374 may be provided as a security module for mobile computing device 350, and may be programmed with instructions that permit secure use of mobile computing device 350. In addition, secure applications may be provided via the SIMM cards, along with additional information, such as placing identifying information on the SIMM card in a non-hackable manner.

Expansion memory 374 may include, for example, flash memory and/or NVRAM memory. In some implementations, a computer program product is tangibly embodied in an information carrier. The computer program product contains instructions that, when executed, perform one or more methods, such as those described herein. The information carrier is a computer-or machine readable-medium, such as memory 364, expansion memory 374, or a memory on processor 352, that may be received, for example, over transceiver 368 or external interface 362.

Mobile computing device 350 may communicate wirelessly through communication interface 366, which may include digital signal processing circuitry where necessary. Communication interface 366 may provide for communications under various modes or protocols, such as GSM voice calls, SMS, EMS or MMS messaging, CDMA, TDMA, PDC, WCDMA, CDMA2000, or GPRS, among others. Such communication may occur, for example, through transceiver 368. In addition, short-range communication may occur, such as using a Bluetooth, WiFi, or other such transceiver. In addition, GPS (Global Positioning System) received module 370 may provide additional navigation-and location-related wireless data to mobile computing device 350, which may be used as appropriate by applications running on mobile computing device 350.

Mobile computing device 350 may also communicate audibly using audio codec 360, which may receive spoken information from a user and covert the received spoken information to digital information. Audio codec 360 may likewise generate audible sound for a user, such as through a speaker, e.g., in a handset of mobile computing device 350. Such sound may include sound from voice telephone calls, may include recorded sound, such as voice messages, music files, etc., and may also include sound generated by applications operating on mobile computing device 350.

Mobile computing device 350 may be implemented in a number of different forms, as shown in the figure. For example, mobile computing device 350 may be implemented as a cellular telephone 380. Mobile computing device 350 may also be implemented as part of a smart phone 382, personal digital assistant, or other similar mobile device.

Various implementations described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications, or code, include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device, such as magnetic discs, optical disks, memory, Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor.

The contents of computer-readable medium may physically reside in one or more memory devices accessible by server. Computer-readable medium may include a database of entries corresponding to loading, shipping, offloading, tracking, and customer management. Each of the entries may include, but are not limited to, shipping organization, shipped product, receiving organization, quantity, quantity type, reference number, type, comments, loading date, delivery date, and other fields. The information fields store in a database a user or organization's information as set forth herein. Said fields are customizable and may include additional or alternative fields based on the user's needs. Said information is accessible through the server.

To provide for interaction with a user, the techniques described herein can be implemented on a computer having a display device, such as a CRT (cathode ray tube), LCD (liquid crystal display), or LED (Light Emitting Diode) monitor, for displaying information to the user and a keyboard and a pointing device by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The techniques described herein can be implemented in a computing system that includes a back end component, such as a data server, or that includes a middleware component, such as an application server, or that includes a front end component, such as a client computer having a graphical user interface or Web browser through which a user can interact with an implementation of the techniques described here, or any combination of such back end, middleware, or front end components. The components of the system can be interconnected by any form of medium of digital communication.

A preferred implementation of the invention discloses a system and method for managing the delivery of bulk materials. In a preferred embodiment, the system provides for tracking deliveries through at least three parties involved in the process, and ultimately opening a delivery valve at the unload site when the delivery arrives.

Consistent with the disclosure set forth herein, the system and method consists of web and mobile phone versions. In some embodiments, the system may be implemented on a mobile phone application. In these embodiments, a user may utilize a mobile phone and scan an identification code using the camera function on the smartphone. In other embodiments, a traditional barcode scanner may be utilized. It is understood that, consistent with this disclosure, any device for scanning a bar code may be utilized. As detailed below, a “load” is then created in the database with a tank origin number, location, chemical name, hazard category and other pertinent information identified in the load. The custody is then transferred to a transport company for delivery. In a preferred embodiment, a user will scan a barcode that is connected to the transport container and this information will be added to the load. The user then accesses the system and selects the destination based on potential options that contain the same chemical as the load tank. The transport company may then depart for delivery. As used herein, the identification codes and the barcodes may be replaced with GPS tags, RFID tags, and the like.

Upon arriving at an offload facility, a similar tank identification code is scanned to initiate the load validation process. The user then scans one of the identification codes that were connected to the transport container at the load site. The system then confirms the chain of custody ensuring that the good from the origin vessel, to the transport container to the ultimate delivery vessel all match. Upon receipt of confirmation from the database, the system may send an open command to an appropriate unload valve, or other remote controlled locking devices, located on the end user's tank fill line. In a preferred embodiment, the system may contain hardware comprising a relay bank, a cell signal receiver or other internet connected device, and two safety interlocks. The system sends the command to the cell receiver via SMS text messaging, or to a network or internet connected device, which in turn powers the correct relay to open the correct valve. Preferably, the two safety interlocks are sensors. One sensor is a proximity sensor, which may be photoelectric, inductive capacity, or like, that senses that the tank truck unloading hose is connected to the correct tank. The second sensor is a high level switch in the top of the tank that will stop the offload and prevent overfill if there is not enough head space in the tank to hold the entire load.

If the chain of custody check does not indicate a match of goods then the system sends a signal to a visual or an audible alarm located on the hardware or valve. Alarm messaging may also be displayed on the user's smartphone indicating the incorrect tank has been scanned.

As described below, the use of smartphone technology allows for all scanning to take place at the point of action as opposed to entering information into a remote data entry device, or bringing paperwork from a remote office. Additionally, the hardware set forth herein allows for information to be passed through a data center directly from the load site to the offload site without any human interface eliminating the potential for error. This moves the process from administrative controls to engineering controls which is generally preferred with any safety system. Further, as set forth herein, the system is in full control of the final offload valve and will only open the valve if the chain of custody is correct and pure. Nonetheless, systems and methods of the invention set forth herein may function without using a smartphone. Additionally, alternative hardware and valve controls may be utilized and still fall within the scope of the disclosure.

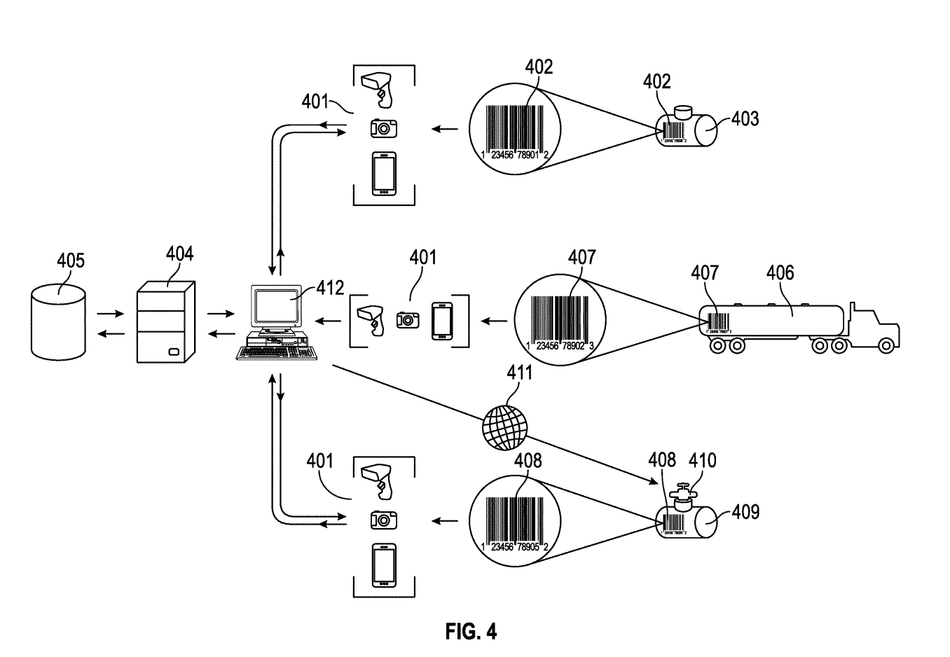

As set forth herein, a preferred implementation of the disclosure is a method for delivering cargo. As illustrated in FIG. 4, generally, a user uses a scanning device 401 to scan a first identification code 402 located on an origin vessel 403. This first identification code 403 is preferably attached to an origin vessel 403 holding goods. However, it may also be possible that the first identification code 402 is removable or not connected to the vessel 403. For example, the first identification code 402 may be a placard or card that the delivery driver carries with him inside of the vehicle. In this way, the driver may have a unique identification code 402 for the load in which he is carrying, but the identification code 402 will not be attached to the vessel 403. Once scanned, a server 404 will retrieve information relating to the origin vessel from a database 405. This information may be a chemical name, class, toxicity, storage site, cost, expiration date, GPS coordinates and other similar data. The various information and data relating to the product in the origin vessel is then stored in the database 405. Preferably, this information is stored as a load. In this way, other information relating to the delivery of a certain load may be grouped together as an individual load or delivery.

Next, a chain of custody from the origin vessel 403 to a transport container 406 is created. As such, a user uses a scanning device 401 to scan a second identification code 407 located on a transport container 406. In an alternative embodiment the second identification code 407 is removable and not connected to the transport container 406. For example, the second identification code 407 could be a placard or card that the delivery driver carries with him inside of the vehicle. In this way, the driver may have a unique identification code 407 for the transport container 406 he is transporting.

Once scanned, a server 404 retrieves information relating to the transport container 406. This information may relate to the type of container, capacity of the container, storage limitations and restrictions, and other similar data. The system stores the information and data relating to the transport container in a database 405. This information is grouped to the same load or delivery. In this way, the information associated with the origin vessel 403 and transport container 406 are grouped together as a single load.

In a preferred embodiment, before proceeding with a delivery, a user retrieves one or more available drop-off locations for delivering the goods. In a preferred embodiment, the available drop-off locations are prepopulated in the system. In other embodiments the drop-off location information may be uploaded by a user. A user then selects one of the locations. The system stores information relating to the drop-off location in the database 405. This information may include address, hours of operation, number of delivery vessels, delivery vessel information, chemical types accepted, and other similar data. The drop-off location information and data is grouped to the load. In this way, the information associated with the origin vessel 403, the transport container 406, and the drop-off location are grouped together as a single load.

The goods are transported to the selected drop-off location and a third identification code 408 located on a delivery vessel 409 is scanned. In an alternative embodiment the third identification code 408 is removable and not connected to the delivery vessel 409. The system retrieves information relating to the delivery vessel 409. The information relating to the delivery vessel may include tank capacity, chemical compatibility, GPS coordinates, and other similar data. The system stores information relating to the delivery vessel 409 in a database 405. This information in grouped to the load. In this way, the information associated with the origin vessel 403, the transport container 406, the drop-off location, and the delivery vessel 409 are grouped together as a single load.

In a preferred embodiment, before a delivery is completed, a transport container will arrive to drop-off facility. A user using a scanning device 401 scans the second identification code 407 associated with the transport container 406. The system uses the identification codes 407 of the transport container 406 to verify that a chain of custody exists with the load. A proper chain of custody is the pre-set custody of a product from a selected origin vessel, to a selected transport container, to a selected delivery vessel as identified by scanning the third identification code 408 associated with the delivery vessel 409. This information is stored in a database and grouped to the specific load. If a correct chain of custody exists, the system controls a valve 410. This valve 410 may be located on the delivery vessel 409, delivery vessel line, or any other proximate location to the delivery vessel 409. Generally, if the chain of custody is correct, the signal sent to the valve will open the valve. In a preferred embodiment, the signal is sent via a network 411. This network may be an internet, telephone, cellular, or other similar network for communicating information. Once opened, the goods may be transported into the delivery vessel 409.

If the chain of custody is not correct, the system will alert an alarm and will not open the valve 410 on the delivery vessel 409. In a preferred embodiment, the alarm may be located on the delivery vessel 409. However, it is understood that the alarm may be located in many locations, including on a delivery person's cell phone, designated device, or other similar apparatus. The final outcome of a correct or incorrect chain of custody is stored in the database 405 and associated with a load.

In one embodiment the valve 410 may include at least one of a relay bank, a programmable logic controller (PLC), a cell signal receiver, a proximity sensor, and an overfill sensor. However, it is not required that a specific type of valve 410 be used. It is preferred that the valve 410 be configured such that it may be controlled by using a network 411 connected device or an internet 411 connected device.

In a preferred embodiment, a load may include information relating to an origin vessel identification code 402, an origin vessel 403, a transport container identification code 407, a transport container 406, a delivery vessel identification code 408, a delivery vessel 409, an origin vessel location, a transport container location, a transport offload hose location, a delivery vessel location, sufficient space in vessel to accept load, a chemical name, a hazard category, and other similar information.

Different embodiments of the disclosure may use different identification codes. It some embodiments barcodes may be utilized. As used herein, barcodes are optical, machine-readable, representations of data. The data usually describes something about the object that carries the barcode. Barcodes may systematically represent data by varying the widths and spacing of parallel lines, and may be referred to as linear or one-dimensional (1D). Additionally, two-dimensional (2D) codes may be used, using rectangles, dots, hexagons and other geometric patterns in two dimensions. These barcodes may be scanned by special optical scanners called barcode readers or by utilizing devices such as smartphones with cameras.

It is understood that the embodiments of the system set forth in the disclosure may utilize any identification means known. For example, identification codes may also mean RFID tags. Radio-frequency identification (RFID) uses electromagnetic fields to automatically identify and track tags attached to objects. The tags contain electronically stored information. Passive tags collect energy from a nearby RFID reader's interrogating radio waves. Active tags have a local power source such as a battery and may operate at hundreds of meters from the RFID reader. In yet another embodiment, the identification code may be a global positioning system tracking device. In yet another embodiment, at least one of the origin vessel, delivery vessel, or transport container coes codes are global positioning system (GPS) coordinates or GPS tracking devices.

Another embodiment of the current disclosure comprises a method for accurately delivering cargo. In this embodiment, as illustrated in FIG. 4, origin vessel 403, delivery vessel 409, and transport container 406 information is stored in a database 405. In a preferred embodiment the origin vessel 403 information relates to a specific vessel, the transport container 406 information relates to a specific transport container, and the delivery vessel 409 information relates to a specific vessel. Preferably, a plurality of vessel and transport containers may be stored in the database 405 for selection. In this case, information relating to each of the plurality of vessels and transport containers will be stored in the database. In an alternative embodiment, a user may upload information relating to specific vessels and transport containers into the system.

Unique identification codes for each of the vessels and transport containers are provided by the system. In a preferred embodiment, the unique identification codes may include data relating to each of the vessels and transport containers. This data may include chemical storage, transportation, and capacity information.

Once a user is ready to begin transporting goods, he scans the unique identification code 402 of the origin vessel 403. Once scanned, the system stores information relating to the origin vessel in a database 405 and the information is categorized with a load. Next, a user may scan a unique identification code 407 of a transport container 406. Once scanned, the system stores information relating to the transport container in a database 405 and the information is categorized with the load. Once the origin vessel 403 and transport container 406 are associated with a load, a user may load the transport container 406 with goods from the origin vessel 403.

Once the goods are loaded they are transported from the origin vessel 403 to the delivery vessel 409. The origin vessel 403 may be at the pick-up location and delivery vessel 409 may be at the drop-off location. In an alternative embodiment, the transport container 406 may be equipped with a GPS device. In this embodiment, the location of the transport container 406 may be tracked and stored with the load in the database 405.

Before offloading the goods to the delivery vessel 409 at the drop-off location, a user utilizing a scanning device 401 scans the unique identification code 408 of the delivery vessel 409. The system stores information relating to the delivery vessel 409 in the database 405 and the stored information is categorized with the load. The system then analyzes whether the desired chain of custody exists between the origin vessel 403, transport container 406, and delivery vessel 409. As set forth herein, a desired chain of custody exists if each of the original vessel 403, transport container 406, and delivery vessel 409 are the preselected respective vessels and containers. Depending on the chain of custody, the system may send a signal to a valve 410 located proximate to the delivery vessel 409 or to an alarm.

In a preferred embodiment, if there is a correct chain of custody from the origin vessel, to the transport container, to the delivery vessel, the system stores the occurrence of a positive chain of custody in the database. Once stored, the system sends a signal via a network to the valve to open and allow delivery from the transport container into the delivery vessel.

If there is an incorrect chain of custody from the origin vessel, to the transport container, to the delivery vessel, the system will store information relating to the incorrect chain of custody in a database. This stored information will be grouped to the load. The system may then send a signal to trigger an alarm located on or near a vessel fill line of the delivery vessel.

Yet another embodiment of the disclosure set forth herein comprises a processor, a control valve, and a non-transitory computer-readable medium for controlling shipments of bulk materials. In a preferred embodiment, the non-transitory computer-readable medium is coupled to the processor and control valve and has instructions stored thereon, which, when executed by the processor, cause the processor to perform certain operations. In a preferred implementation, the operations may comprise receiving, from a user device, data responsive to scanning a first identification code 402 located on an origin vessel 403, wherein information relating to the first identification code 402 is provided and stored. Furthermore, the operations may comprise, receiving, from a user device 401, data responsive to scanning a second identification 407 code located on a transport container 406, wherein information relating to the second identification code 407 is provided and stored. The operations may further comprise receiving, from a user device 401, data responsive to scanning a third identification code 408 located on a delivery vessel 409, wherein information relating to the third identification code 408 is provided and stored. The operations may further comprise verifying, by the processor 412, whether a chain of custody exists from the origin vessel 403, to the transport container 406, to the delivery vessel 409. The operations further comprise storing all information relating to the identification codes and chain of custody, and any action to be taken in response to the stored information and chain of custody in a database 405.

The system set forth herein may further comprise a user management system allowing an administrator to group users by individual organizations or entities and limit their access to only specific vessel and container information for their organization or entity, or setup system wide users who manage the overall network. The system further comprises a comprehensive shipment management system that tracks all of the information passing through the system and makes it available for later use. The system further comprises reporting tools to export useful analytics from the system in various formats including HTML and Excel.

In a preferred embodiment, the system is written in C# and utilizes Microsoft ASP.NET. However, it is understood that embodiments of the invention disclosed herein may be created from any language using any framework. In one implementation the system comprises a suite of web services that power all of the applications and tools that comprise the system. For example, web-based management tools, as well as the web-based delivery application, both interface with the same set of services.

In one embodiment the system utilizes a database management system such as Microsoft SQL or similar. It is understood that various servers may be used to access stored data. Users must connect through a service or server before accessing stored data. This ensures all access to the database has been authenticated and restricts users to changes within their organization or entity, as set forth herein.

In a preferred embodiment, a user uses a web browser to navigate to a system website. The system website comprises a plurality of web pages. In a preferred embodiment, each webpage is accessed via tabs on the system website homepage or other system webpage. Links or tabs allow a user to navigate from one page to another. Implementations of the invention further comprise web-based forms with text fields therein. In a preferred embodiment, said text fields auto populate predetermined forms, webpages, databases, servers, or other targeted destinations. In one embodiment, a user accesses a webpage that accesses a database via a server.

In a preferred embodiment, users with required permission levels may access a system reporting interface. The system reporting interface consolidates organization or entity information and allows a user to filter said information based on specific fields, sales, and other relevant categories. This information is stored in a system database.

The system and method set forth herein may find utility in many areas in which controlled delivery of goods is desired. The system may find particular utility in the field associated with delivery and tracking of expensive and toxic chemicals. For example, a manufacturer may desire to transport one-thousand liters of hydrochloric acid from its manufacturing facility to a client. Due to the dangerous and toxic nature of hydrochloric acid, it is imperative that the containers and vessels me configured to accept the acid. For example, the origin vessel at the manufacturing facility may have an identification code which includes information showing the chemical contained within is the proper chemical-hydrochloric acid. Next, before loading the chemical onto the transport container, the user will scan an identification code of the designated transport container. The identification code will have information relating to the type of chemicals that may be transported therein. If the system recognizes that the transport container is situated to receive the goods, the system will recognize a positive chain of custody. In one embodiment the system may alert a user that the chain of custody is true and correct. The chemical is loaded into the transport container and transported to a delivery vessel. The user will scan the identification code of the delivery vessel to verify that the vessel is the designated vessel for the delivery and is configured to receive the specific chemicals. If the chain of custody is correct, the system controls a valve on a supply line of the delivery vessel and the chemical may be offloaded into the delivery vessel. If the chain of custody is not correct, the system triggers an alarm and does not open the valve on the supply line of the delivery vessel.

It will also be apparent to one of ordinary skill in the art that aspects of the invention, as described above, may be implemented in many different forms of software, firmware, and hardware in the implementations illustrated in the figures. The actual software code or specialized control hardware used to implement aspects consistent with the present invention is not limiting of the present invention. Thus, the operation and behavior of the aspects were described without references to the specific software code—it being understood that one of ordinary skill in the art would be able to design software and control hardware to implement the aspects based on the description herein.

1. A method for delivering cargo comprising:
a. Scanning a first identification code located on an origin vessel, said first identification code being attached to an origin vessel holding goods,
b. Retrieving, by a server, information relating to the origin vessel,
c. Storing said information relating to the origin vessel in a database, said stored information grouped to a load,
d. Scanning a second identification code located on a transport container,
e. Retrieving, by a server, information relating to said transport container,
f. Storing information relating to said transport container in a database, said stored information grouped to said load,
g. Retrieving, by a server from the database, one or more available drop-off locations for delivering the goods;
h. Selecting one of the locations;
i. Storing information relating to said drop-off location in the database, said drop-off location information grouped to said load;
j. Transporting said specific goods to the selected drop-off location;
k. Scanning, at said drop-off location, a third identification code located on a delivery vessel;
l. Retrieving, by the server, information relating to said delivery vessel;
m. Storing information relating to said delivery vessel in a database, said stored information grouped to said load;
n. Scanning, at said drop-off location said second identification code located on the transport container;
o. Verifying, by the server, whether a chain of custody exists from the origin vessel, to the transport container, to the delivery vessel, and
p. Controlling a valve on the delivery vessel.

2. The method of claim 1, further comprising said identification code located on said transport container is identifies the goods that are intended to be offloaded into said delivery vessel.

3. The method of claim 1, further comprising:
a. If there is a correct chain of custody from the origin vessel, to the transport container, to the delivery vessel, storing information relating to said correct chain of custody in a database, said stored information grouped to said load, and
b. Sending a signal to a valve located on a vessel fill line of the delivery vessel, and
c. Opening said valve located on the delivery vessel.

4. The method of claim 1, further comprising:
a. If there is an incorrect chain of custody from the origin vessel, to the transport container, to the delivery vessel, storing information relating to said incorrect chain of custody in a database, said stored information grouped to said particular load, and
b. Sending a signal to an alarm, and
c. Triggering the alarm.

5. The method of claim 4, said alarm being located at the delivery vessel.

6. The method of claim 4, said alarm being located on a device of a transport container delivery person.

7. The method of claim 1, further comprising said load includes at least one of an origin vessel identifier, a transport container identifier, a delivery vessel identifier, an origin vessel location, a transport container location, a transport offload hose location, a delivery vessel location, sufficient room in vessel to accept load, a chemical name, and a hazard category.

8. The Method of claim 1, further comprising said valve comprises a programmable logic controller, a relay bank, a cell signal receiver, a proximity sensor, or an overfill sensor.

9. The method of claim 1, further comprising controlling the valve on the delivery vessel by using at least one of using a network connected device or an internet connected device.

10. The method of claim 1, at least one of said identification codes is a RFID tag.

11. The method of claim 1, at least one of said identification codes is global positioning system tracking device.

12. The method of claim 1, at least one of said original and delivery vessel codes being global positioning system coordinates.

13. A method for accurately delivering cargo comprising:
a. Storing origin vessel, delivery vessel, and transport container information in a database;
i. Said origin vessel information relating to a specific vessel;
ii. Said transport container information relating to a specific transport container
iii. Said delivery vessel information relating to a specific vessel
b. Providing a unique identification code for each of the origin vessel, transport container, and delivery vessel, said unique identification codes providing information relating to each of the respective origin vessel, transport container, and delivery vessel;
c. Scanning the unique identification code of the origin vessel;
d. Storing information relating to the origin vessel in a database, said stored information being categorized with a load;
e. Scanning the unique identification code of the transport container;
f. Storing information relating to the transport container in a database, said stored information being categorized with the load;
g. Loading the transport container with goods from the origin vessel;
h. Transporting the goods from the origin vessel to the delivery vessel;
i. Scanning the unique identification code of the delivery vessel;
j. Storing information relating to the delivery vessel in the database, said stored information being categorized with the load;
k. Analyzing whether the desired chain of custody exists between the origin vessel, transport container, and delivery vessel; and
l. Sending a signal to a valve located on the supply line of a delivery vessel for controlling the orientation of the valve.

14. The method of claim 13, further comprising:
a. If there is a correct chain of custody from the origin vessel, to the transport container, to the delivery vessel, storing information relating to said correct chain of custody in a database, said stored information grouped to the load, and
b. Sending a signal to a valve located on a vessel fill line of the delivery vessel, and
c. Opening said valve located on the delivery vessel.

15. The method of claim 13, further comprising:
a. If there is an incorrect chain of custody from the origin vessel, to the transport container, to the delivery vessel, storing information relating to said incorrect chain of custody in a database, said stored information grouped to the load, and
b. Sending a signal to an alarm located on a vessel fill line of the delivery vessel, and
c. Triggering the alarm.

16. The method of claim 13, further comprising controlling the valve on the delivery vessel using at least one of a network connected device or an internet connected device.

17. The method of claim 13, at least one of said identifications codes is a RFID tag.

18. The method of claim 13, at least one of said identifications codes is a global positioning system tracking device.

19. The method of claim 13, at least one of said original and delivery vessel identification codes being global positioning system coordinates.

20. A system, comprising:
a. a processor;
b. a control valve, and
c. a non-transitory computer-readable medium coupled to the processor and control valve and having instructions stored thereon, which, when executed by the processor, cause the processor to perform operations comprising:
i. Receiving, from a user device, data responsive to scanning a first identification code located on an origin vessel, wherein information relating to the first identification code is provided and stored;
ii. Receiving, from a user device, data responsive to scanning a second identification code located on an transport container, wherein information relating to the second identification code is provided and stored;
iii. Receiving, from a user device, data responsive to scanning a third identification code located on an delivery vessel, wherein information relating to the third identification code is provided and stored;
iv. Verifying, by the processor, whether a chain of custody exists from the origin vessel, to the transport container, to the delivery vessel,
v. storing all information relating to the identification codes and chain of custody, and any action to be taken in response to the stored information and chain of custody in a database.
